(19) United States
(12) Patent Application Publication
(10) Pub. No.: US 2020/0097769 A1
(43) Pub. Date: Mar. 26, 2020

(54) REGION PROPOSAL WITH TRACKER FEEDBACK

(71) Applicant: Avigilon Corporation, Vancouver (CA)

(72) Inventors: Aleksey Lipchin, Newton, MA (US); Yin Wang, Malden, MA (US); Xiao Xiao, Reading, MA (US); Hao Zhang, Winchester, MA (US); Chia Ying Lee, Medford, MA (US)

(73) Assignee: Avigilon Corporation, Vancouver (CA)

(21) Appl. No.: 16/575,297

(22) Filed: Sep. 18, 2019

Related U.S. Application Data
(60) Provisional application No. 62/734,099, filed on Sep. 20, 2018.

(51) Int. Cl. G06K 9/62; G06K 9/20; G06K 9/00

(52) U.S. Cl. CPC G06K 9/6257; G06K 9/2054; G06K 2209/21; G06K 9/00718; G06K 9/6219

(57) ABSTRACT

Methods, systems, and techniques for object detection and tracking are provided. A system may include a module configured to generate a plurality of region proposals, each region proposal comprising a part of a video frame, a CNN pre-trained for object detection, the plurality of region proposals being input to the CNN; a tracker for tracking one or more targets based on outputs from the CNN across the series of video frames and generating tracking information on the one or more targets; and a module further configured to refine the plurality of region proposals to be input to the CNN, based on the tracking information.

### RELATED APPLICATIONS

This application claims the benefit of U.S. Provisional Patent Application No. 62/734,099, filed on Sep. 20, 2018, which is hereby incorporated by reference in its entirety.

### TECHNICAL FIELD

The present invention relates to image processing, and more particularly to object detection in a series of image data.

### BACKGROUND

Automated security and surveillance systems typically employ video cameras or other image capturing devices or sensors to collect image data such as video or video footage. In the simplest systems, images represented by the image data are displayed for contemporaneous screening by security personnel and/or recorded for later review after a security breach. In a typical surveillance system, one may be interested in detecting objects such as humans, vehicles, animals, etc. that move through the environment.

Computer-implemented detection of objects in image data captured by the cameras can significantly facilitate the task of reviewing relevant video segments by the security personnel. For example, convolutional neural networks (CNNs) may be one of tools for such image data processing applications. However, CNNs typically require large computation resources.

That being said, computer-implemented analysis of video to detect and recognize objects and which objects are similar requires substantial computing resources especially as the desired accuracy increases.

### SUMMARY

According to a first aspect, there is provided a method comprising: generating a plurality of region proposals, each region proposal comprising a part of a video frame, the region proposals being input to a convolutional neural network (CNN) pre-trained for object detection; detecting, using the CNN, one or more objects in a series of video frames; tracking one or more targets based on outputs from the CNN across the series of video frames and generating tracking information on the one or more targets; and refining the plurality of region proposals to be input to the CNN, based on the tracking information.

The outputs from the CNN may comprise bounding boxes for detected objects together with a classification score (or confidence). Each bounding box is defined by a location as well as vertical and horizontal dimensions (i.e., width and height).

The method may comprise categorizing each of the one or more targets into a status category, based on the outputs from the CNN, the status category of a target indicating the time since the target was likely detected by the CNN.

The method may comprise for each of the one or more targets, identifying a region of the region proposals or a new region likely containing the target.

The method may comprise calculating a region priority score of the identified region based on a priority score of the target that is likely within the identified region, the priority score of the target being determined based on the corresponding status category.

The method may comprise sorting regions including the identified regions and the region proposals in the descending order of the region priority scores, and selecting Nmax regions as final proposal regions to be input to the CNN, wherein Nmax represents an upper threshold number.

The region proposals may include a non-zero motion vector and are selected from a plurality of predefined regions covering the entire frame.

The predefined regions may be generated from an object size map. For a given location on the object size map, a map value may represent an estimated object size in pixels.

The total number of the region proposals may satisfy the upper threshold number criterion.

The method may comprise adding an additional region to the region proposals until the number of region proposals satisfy the upper threshold number criterion.

The additional region may be determined using default regions and/or a last checking time map, the last checking time map describing the time since the local region was input to the CNN.

The method may comprise merging some of the selected region proposals based on a motion vector density. The motion vector density being a percentage of pixels inside of a region proposal that have non-zero motion vectors.

The method may comprise, for each of the one or more targets, identifying a region of the region proposals in which the target is likely contained, based on the corresponding bounding box.

The method may comprise creating a new region for a target that is not likely within by any of the region proposals and is likely within the new region.

The method may comprise calculating a region priority score for each region that likely contains a target, based on the priority score of the target, the priority score of the target being determined based on the corresponding status category.

The method may comprise sorting regions including any region that likely contains a target and the region proposals, in descending order of the region priority scores, and selecting Nmax regions as final proposal regions, wherein Nmax represents an upper threshold number.

According to a further aspect, there is provided a computer readable medium storing instructions, which when executed by a computer cause the computer to perform a method comprising: generating a plurality of region proposals, each region proposal comprising a part of a video frame, the plurality of region proposals being input to a CNN pre-trained for object detection; detecting, using the CNN, one or more objects in a series of video frames; tracking one or more targets based on outputs from the CNN across the series of video frames and generating tracking information on the one or more targets; and refining the plurality of region proposals to be input to the CNN, based on the tracking information.

According to a further aspect, there is provided a system comprising: a module for generating a plurality of region proposals, each region proposal comprising a part of a video frame; a CNN pre-trained for object detection, the plurality of region proposals being input to the CNN; a tracker for tracking one or more targets based on outputs from the CNN across the series of video frames and generating tracking information on the one or more targets; and a module further configured to refine the plurality of region proposals to be input to the CNN, based on the tracking information.

### BRIEF DESCRIPTION OF THE DRAWINGS

The detailed description refers to the following figures, in which:

FIG. 1 illustrates a block diagram of connected devices of a video capture and playback system according to an example embodiment;

FIG. 2A illustrates a block diagram of a set of operational modules of the video capture and playback system according to one example embodiment;

FIG. 2B illustrates a block diagram of a set of operational modules of the video capture and playback system according to one particular example embodiment;

FIG. 3 illustrates a block diagram of a set of operational modules of a video analytics module implemented in the video capture and playback system according to one example embodiment;

FIG. 4 illustrates a block diagram of a set of operational modules of an object detection and tracking module implemented in the video capture and playback system according to one example embodiment;

FIG. 5 illustrates a block diagram of a set of operational modules of a region proposal module implemented in the object detection and tracking module according to one example embodiment;

FIG. 6 illustrates a block diagram of a set of operational modules of a tracker implemented in the object detection and tracking module according to one example embodiment;

FIG. 7 illustrates a state transition diagram of a status category assigned by the tracker according to one example embodiment;

FIG. 8 illustrates an example of priority scores for the status categories assigned by the tracker according to one example embodiment;

FIGS. 9A and 9B illustrate flow diagrams of an example embodiment of a process for generating region proposals according to one example embodiment;

FIGS. 10A to 10F each illustrates one example of a default region utilized in the process shown in FIG. 9A;

FIG. 10G illustrates a combination of the default regions shown in FIGS. 10A to 10F;

FIG. 11 illustrates an example of region priority scores utilized to select final region proposals according to one example embodiment;

FIG. 12 illustrates another example of region priority scores derived from inputs, tracker feedback, and a detection statistics submodule;

FIG. 13 illustrates a flow diagram of the region proposal detection statistics submodule according to one example embodiment; and

FIG. 14 illustrates a flow diagram of a process for generating region proposals according to another example embodiment of the submodule 504 implemented in the region proposal module 402.

### DETAILED DESCRIPTION

Numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending in the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through one or more intermediate elements or devices via an electrical element, electrical signal or a mechanical element depending on the particular context.

Herein, an image may include a plurality of sequential image frames, which together form a video captured by the video capture device. Each image frame may be represented by a matrix of pixels, each pixel having a pixel image value. For example, the pixel image value may be a numerical value on grayscale (ex; 0 to 255) or a plurality of numerical values for colored images. Examples of color spaces used to represent pixel image values in image data include RGB, YUV, CYKM, YCBCR 4:2:2, YCBCR 4:2:0 images.

“Metadata” or variants thereof herein refers to information obtained by computer-implemented analysis of images including images in video. For example, processing video may include, but is not limited to, image processing operations, analyzing, managing, compressing, encoding, storing, transmitting and/or playing back the video data. Analyzing the video may include segmenting areas of image frames and detecting visual objects, tracking, and/or classifying visual objects located within the captured scene represented by the image data. The processing of the image data may also cause additional information regarding the image data or visual objects captured within the images to be output. For example, such additional information is commonly understood as metadata. The metadata may also be used for further processing of the image data, such as drawing bounding boxes around detected objects in the image frames.

As will be appreciated by one skilled in the art, the various example embodiments described herein may be embodied as a method, system, or computer program product. Accordingly, the various example embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the various example embodiments may take the form of a computer program product on a computer-usable storage medium having computer-usable program code embodied in the medium

Any suitable computer-usable or computer readable medium may be utilized. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device.

Computer program code for carrying out operations of various example embodiments may be written in an object oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

Various example embodiments are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

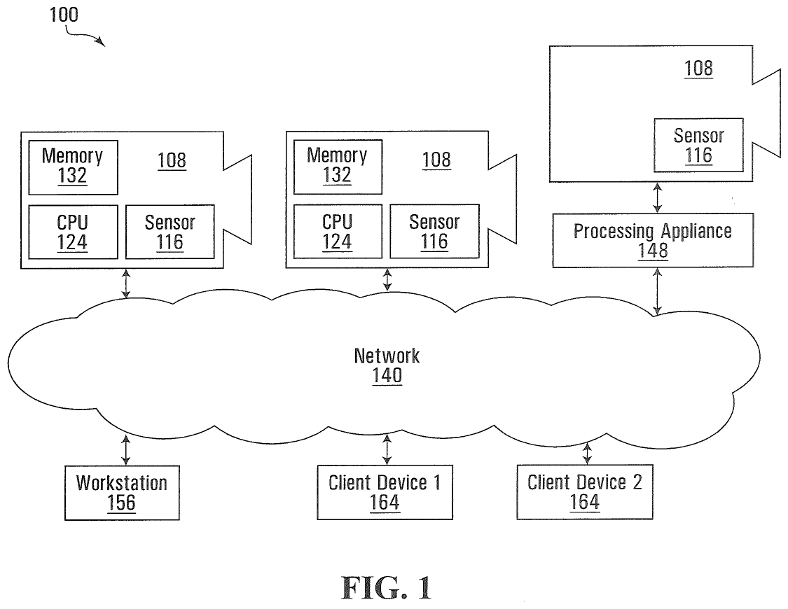

Referring now to FIG. 1, therein illustrated is a block diagram of connected devices of a video capture and playback system 100 according to an example embodiment. For example, the video capture and playback system 100 may be used as a video surveillance system. The video capture and playback system 100 includes hardware and software that perform the processes and functions described herein.

The video capture and playback system 100 includes at least one video capture device 108 being operable to capture a plurality of images and produce image data representing the plurality of captured images. The video capture device 108 or camera 108 is an image capturing device and includes security video cameras.

Each video capture device 108 includes at least one image sensor 116 for capturing a plurality of images. The video capture device 108 may be a digital video camera and the image sensor 116 may output captured light as a digital data. For example, the image sensor 116 may be a CMOS, NMOS, or CCD. In some embodiments, the video capture device 108 may be an analog camera connected to an encoder.

The at least one image sensor 116 may be operable to capture light in one or more frequency ranges. For example, the at least one image sensor 116 may be operable to capture light in a range that substantially corresponds to the visible light frequency range. In other examples, the at least one image sensor 116 may be operable to capture light outside the visible light range, such as in the infrared and/or ultraviolet range. In other examples, the video capture device 108 may be a multi-sensor camera that includes two or more sensors that are operable to capture light in different frequency ranges.

The at least one video capture device 108 may include a dedicated camera. It will be understood that a dedicated camera herein refers to a camera whose principal features is to capture images or video. In some example embodiments, the dedicated camera may perform functions associated to the captured images or video, such as but not limited to processing the image data produced by it or by another video capture device 108. For example, the dedicated camera may be a surveillance camera, such as any one of a pan-tilt-zoom camera, dome camera, in-ceiling camera, box camera, and bullet camera.

Additionally, or alternatively, the at least one video capture device 108 may include an embedded camera. It will be understood that an embedded camera herein refers to a camera that is embedded within a device that is operational to perform functions that are unrelated to the captured image or video. For example, the embedded camera may be a camera found on any one of a laptop, tablet, drone device, smartphone, video game console or controller.

Each video capture device 108 includes one or more processors 124, one or more memory devices 132 coupled to the processors and one or more network interfaces. The memory device can include a local memory (such as, for example, a random access memory and a cache memory) employed during execution of program instructions. The processor executes computer program instructions (such as, for example, an operating system and/or application programs), which can be stored in the memory device.

In various embodiments the processor 124 may be implemented by any suitable processing circuit having one or more circuit units, including a digital signal processor (DSP), graphics processing unit (GPU) or video processing unit (VPU) embedded processor, etc., and any suitable combination thereof operating independently or in parallel, including possibly operating redundantly. Such processing circuit may be implemented by one or more integrated circuits (IC), including being implemented by a monolithic integrated circuit (MIC), an Application Specific Integrated Circuit (ASIC), a Field Programmable Gate Array (FPGA), etc. or any suitable combination thereof. Additionally or alternatively, such processing circuit may be implemented as a programmable logic controller (PLC), for example. The processor may include circuitry for storing memory, such as digital data, and may comprise the memory circuit or be in wired communication with the memory circuit, for example.

In various example embodiments, the memory device 132 coupled to the processor circuit is operable to store data and computer program instructions. Typically, the memory device is all or part of a digital electronic integrated circuit or formed from a plurality of digital electronic integrated circuits. The memory device may be implemented as Read-Only Memory (ROM), Programmable Read-Only Memory (PROM), Erasable Programmable Read-Only Memory (EPROM), Electrically Erasable Programmable Read-Only Memory (EEPROM), flash memory, one or more flash drives, universal serial bus (USB) connected memory units, magnetic storage, optical storage, magneto-optical storage, etc. or any combination thereof, for example. The memory device may be operable to store memory as volatile memory, non-volatile memory, dynamic memory, etc. or any combination thereof.

In various example embodiments, a plurality of the components of the image capture device 108 may be implemented together within a system on a chip (SOC). For example, the processor 124, the memory device 116 and the network interface may be implemented within a SOC. Furthermore, when implemented in this way, a general purpose processor and one or more of a GPU and a DSP may be implemented together within the SOC.

Continuing with FIG. 1, each of the at least one video capture device 108 is connected to a network 140. Each video capture device 108 is operable to output image data representing images that it captures and transmit the image data over the network.

It will be understood that the network 140 may be any suitable communications network that provides reception and transmission of data. For example, the network 140 may be a local area network, external network (such as, for example, a WAN, or the Internet) or a combination thereof. In other examples, the network 140 may include a cloud network.

In some examples, the video capture and playback system 100 includes a processing appliance 148. The processing appliance 148 is operable to process the image data output by a video capture device 108. The processing appliance 148 also includes one or more processors and one or more memory devices coupled to a processor (CPU). The processing appliance 148 may also include one or more network interfaces. For convenience of illustration, only one processing appliance 148 is shown; however it will be understood that the video capture and playback system 100 may include any suitable number of processing appliances 148.

For example, and as illustrated, the processing appliance 148 is connected to a video capture device 108 which may not have memory 132 or CPU 124 to process image data. The processing appliance 148 may be further connected to the network 140.

According to one exemplary embodiment, and as illustrated in FIG. 1, the video capture and playback system 100 includes at least one workstation 156 (such as, for example, a server), each having one or more processors including graphics processing units (GPUs). The at least one workstation 156 may also include storage memory. The workstation 156 receives image data from at least one video capture device 108 and performs processing of the image data. The workstation 156 may further send commands for managing and/or controlling one or more of the image capture devices 108. The workstation 156 may receive raw image data from the video capture device 108. Alternatively, or additionally, the workstation 156 may receive image data that has already undergone some intermediate processing, such as processing at the video capture device 108 and/or at a processing appliance 148. The workstation 156 may also receive metadata from the image data and perform further processing of the image data.

It will be understood that while a single workstation 156 is illustrated in FIG. 1, the workstation may be implemented as an aggregation of a plurality of workstations.

The video capture and playback system 100 further includes at least one client device 164 connected to the network 140. The client device 164 is used by one or more users to interact with the video capture and playback system 100. Accordingly, the client device 164 includes at least one display device and at least one user input device (such as, for example, a mouse, keyboard, or touchscreen). The client device 164 is operable to display on its display device a user interface for displaying information, receiving user input, and playing back video. For example, the client device may be any one of a personal computer, laptops, tablet, personal data assistant (PDA), cell phone, smart phone, gaming device, and other mobile device.

The client device 164 is operable to receive image data over the network 140 and is further operable to playback the received image data. A client device 164 may also have functionalities for processing image data. For example, processing functions of a client device 164 may be limited to processing related to the ability to playback the received image data. In other examples, image processing functionalities may be shared between the workstation 186 and one or more client devices 164.

In some examples, the image capture and playback system 100 may be implemented without the workstation 156. Accordingly, image processing functionalities may be wholly performed on the one or more video capture devices 108. Alternatively, the image processing functionalities may be shared amongst two or more of the video capture devices 108, processing appliance 148 and client devices 164.

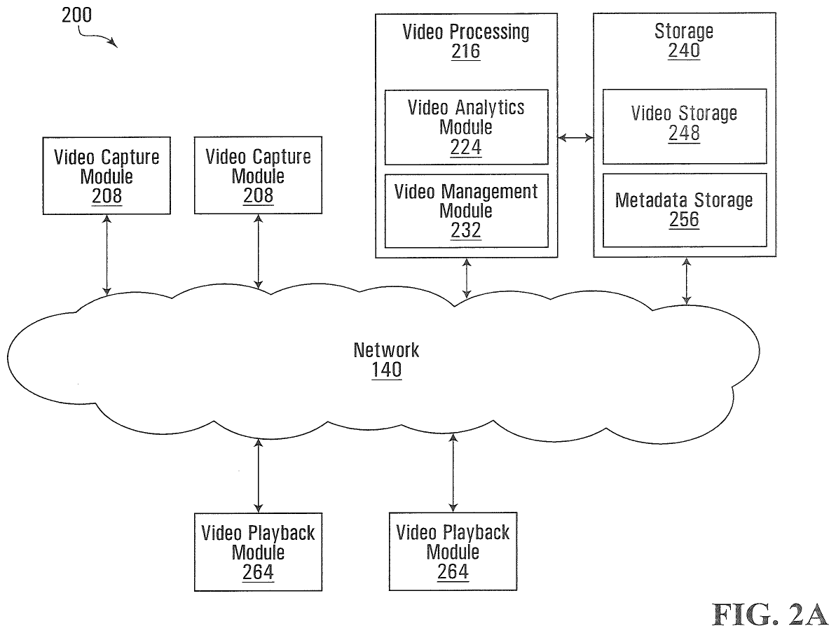

Referring now to FIG. 2A, therein illustrated is a block diagram of a set 200 of operational modules of the video capture and playback system 100 according to one example embodiment. The operational modules may be implemented in hardware, software or both on one or more of the devices of the video capture and playback system 100 as illustrated in FIG. 1.

The set 200 of operational modules include at least one video capture module 208. For example, each video capture device 108 may implement a video capture module 208. The video capture module 208 is operable to control one or more components (such as, for example, sensor 116) of a video capture device 108 to capture images.

The set 200 of operational modules includes a subset 216 of image data processing modules. For example, and as illustrated, the subset 216 of image data processing modules includes a video analytics module 224 and a video management module 232.

The video analytics module 224 receives image data and analyzes the image data to determine properties or characteristics of the captured image or video and/or of objects found in the scene represented by the image or video. Based on the determinations made, the video analytics module 224 may further output metadata providing information about the determinations. Examples of determinations made by the video analytics module 224 may include one or more of foreground/background segmentation, object detection, object tracking, object classification, virtual tripwire, anomaly detection, facial detection, facial recognition, license plate recognition, identifying objects “left behind” or “removed”, unusual motion detection, appearance matching, characteristic (facet) searching, and business intelligence. However, it will be understood that other video analytics functions known in the art may also be implemented by the video analytics module 224.

The video management module 232 receives image data and performs processing functions on the image data related to video transmission, playback and/or storage. For example, the video management module 232 can process the image data to permit transmission of the image data according to bandwidth requirements and/or capacity. The video management module 232 may also process the image data according to playback capabilities of a client device 164 that will be playing back the video, such as processing power and/or resolution of the display of the client device 164. The video management module 232 may also process the image data according to storage capacity within the video capture and playback system 100 for storing image data.

It will be understood that according to some example embodiments, the subset 216 of video processing modules may include only one of the video analytics module 224 and the video management module 232.

The set 200 of operational modules further include a subset 240 of storage modules. For example, and as illustrated, the subset 240 of storage modules include a video storage module 248 and a metadata storage module 256. The video storage module 248 stores image data, which may be image data processed by the video management module. The metadata storage module 256 stores information data output from the video analytics module 224.

It will be understood that while video storage module 248 and metadata storage module 256 are illustrated as separate modules, they may be implemented within a same hardware storage whereby logical rules are implemented to separate stored video from stored metadata. In other example embodiments, the video storage module 248 and/or the metadata storage module 256 may be implemented using hardware storage using a distributed storage scheme.

The set of operational modules further includes at least one video playback module 264, which is operable to receive image data and playback the image data as a video. For example, the video playback module 264 may be implemented on a client device 164.

The operational modules of the set 200 may be implemented on one or more of the image capture device 108, processing appliance 148, workstation 156 and client device 164. In some example embodiments, an operational module may be wholly implemented on a single device. For example, video analytics module 224 may be wholly implemented on the workstation 156. Similarly, video management module 232 may be wholly implemented on the workstation 156.

In other example embodiments, some functionalities of an operational module of the set 200 may be partly implemented on a first device while other functionalities of an operational module may be implemented on a second device. For example, video analytics functionalities may be split between one or more of an image capture device 108, processing appliance 148 and workstation 156. Similarly, video management functionalities may be split between one or more of an image capture device 108, processing appliance 148 and workstation 156.

Referring now to FIG. 2B, therein illustrated is a block diagram of a set 200 of operational modules of the video capture and playback system 100 according to one particular example embodiment wherein the video analytics module 224, the video management module 232 and the storage 240 is wholly implemented on the one or more image capture devices 108. Alternatively, the video analytics module 224, the video management module 232 and the storage 240 is wholly or partially implemented on one or more processing appliances 148.

It will be appreciated that allowing the subset 216 of image data (video) processing modules to be implemented on a single device or on various devices of the video capture and playback system 100 allows flexibility in building the system 100.

For example, one may choose to use a particular device having certain functionalities with another device lacking those functionalities. This may be useful when integrating devices from different parties (such as, for example, manufacturers) or retrofitting an existing video capture and playback system.

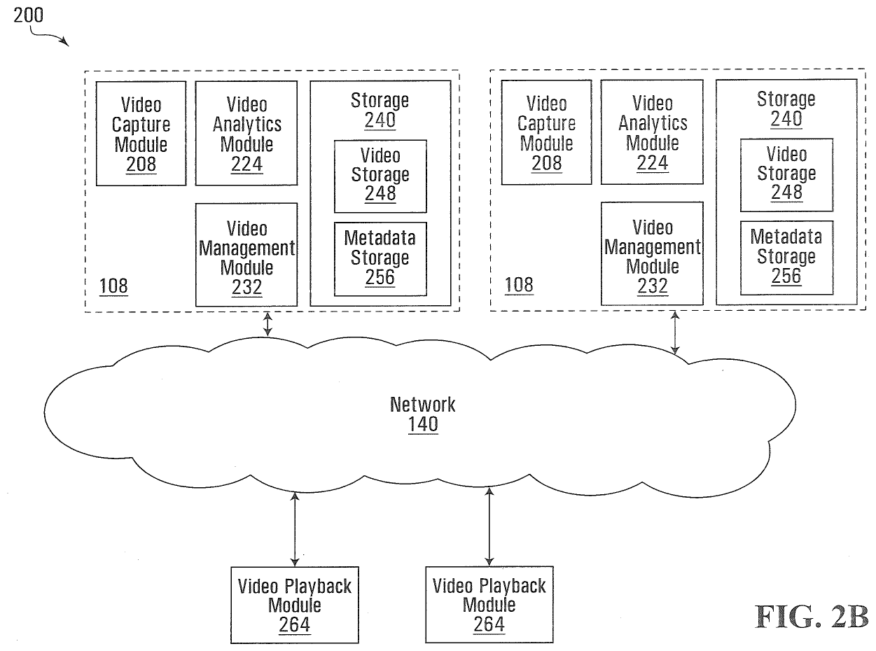

Referring now to FIG. 3, therein illustrated is a block diagram of a set of operational modules of the video analytics module 224 according to one example embodiment. The video analytics module 224 includes a number of modules for performing various tasks. For example, the video analytics module 224 includes an object detection and classification module 302 for detecting objects appearing in the field of view of the video capturing device 108 and generating a location and classification score (or confidence) of each detected object. The object detection and classification module 302 comprises a CNN module 304 that has been pre-trained for detection of multiple objects and classification. The object detection and classification module 302 may also employ any known object detection method such as motion detection and blob detection. The object detection and classification module 302 may include the systems and use the detection methods described in U.S. Pat. No. 7,627,171 entitled “Methods and Systems for Detecting Objects of Interest in Spatio-Temporal Signals,” the entire contents of which is incorporated herein by reference. A visual object may be classified, such as a person, a car or an animal. Additionally or alternatively, a visual object may be classified by action, such as movement and direction of movement of the visual object. Other classifiers may also be determined, such as color, size, orientation, etc. In more specific examples, classifying the visual object may include identifying a person based on facial detection and recognizing text, such as a license plate. Visual classification may be performed according to systems and methods described in U.S. Pat. No. 8,934,709, which is incorporated by reference herein in its entirety.

The video analytics module 224 also includes an object tracking module 306 connected or coupled to the object detection and classification module 302. The object tracking module 306 is operable to temporally associate instances of an object detected by the object detection and classification module 302. The object tracking module 306 comprises a tracker 308 configured to perform object tracking using the outputs of the CNN module 304 and also to provide tracking feedback. The tracker 308 is operable to predict locations of targets in the next frame that are used by the object detection and classification module 302. The term “target” herein refers to a particular object contained in video frames. The object tracking module 306 may further employ any other tracking systems and methods such as those described in U.S. Pat. No. 8,224,029 entitled “Object Matching for Tracking, Indexing, and Search,” the entire contents of which is incorporated herein by reference. The object tracking module 306 generates metadata corresponding to visual objects it tracks. The metadata may be stored in a storage system 340. The metadata may correspond to signatures of the visual object representing the object's appearance or other features. The metadata is transmitted, for example, to a server for processing. In another alternative arrangement, the object detection and classification module 302 and the tracking module 306 may be partially or entirely interrelated.

In a further alternative embodiment, the video analytics module 224 may use facial recognition (as is known in the art) to detect faces in the images of humans and accordingly provide confidence levels. Further, a part of an object, such as an ear of a human, may be detected. Ear recognition to identify individuals is known in the art.

The video analytics module 224 may also include an object indexing module 330 connected to the storage system 340. The object indexing module 330 is operable to generate signatures for objects. The signatures may be stored in metadata database in the storage system 340 and may act as index elements for video images of the objects. The video analytics module 224 also includes an object search module 340 connected to the storage system 340. The object search module 340 may search through signatures stored in the storage system 340 to identify an object in the previously captured images. The video analytics module 224 may comprise modules for filtering out certain types of objects for further processing.

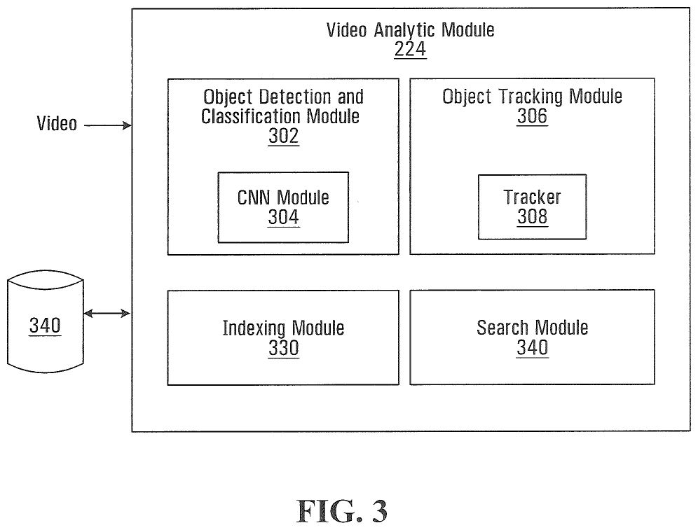

Referring now to FIG. 4, therein illustrated is a block diagram of a set of operational modules of an object detection and tracking module 400 implemented in the video capture and playback system 100, according to one embodiment. The modules of the object detection and tracking module 400 may be implemented by software, hardware, firmware, or combinations thereof.

The object detection and tracking module 400 has a number of modules for performing object detection and tracking. For example, the object detection and tracking module 400 includes a region proposal module 402, a Convolutional Neural Network (CNN) observations module 406, and a tracker 408. In one embodiment, the object detection and tracking module 400 may be implemented in the video analytics module 224, the CNN observations module 406 may be implemented in the CNN module 304 of the object detection and classification module 302, and the tracker 408 may be implemented in the tracker 308 of the object tracking module 306. In one embodiment, the object detection and tracking module 400 may be located in a server that processes videos captured by various devices and communicates with a client, or in a video capture device 108, which communicates with a server. The video is, for example, captured by an image device, such as camera 108, video capture module 208, over a period of time. The meaning of “video” as used herein may include video files and video segments with associated metadata that have indications of time and identify a particular image device.

The object detection and tracking module 400 is operable to process a series of video frames and to detect and track multiple objects. Multiple objects to be detected (objects of interest) may include human and vehicle or other objects. These objects may include static objects and moving objects, such as standing human, moving human, parked vehicle, moving vehicle. The object detection and tracking module 400 may output metadata corresponding to visual objects it detects and tracks.

The region proposal module 402 generates a set of regions that are input to the CNN observations module 406. These regions are referred to as region proposals. A region proposal is configured to cover a part of a video frame that likely (e.g., are predicted with more than 70% certainty, although greater or lower levels of certainty, such as, for example, 90% certainty or 50% certainty could be used) contains one or more objects. In some cases, a region proposal may coincide with the whole frame. Each region proposal may contain representation of one or more objects and/or background. The number of the region proposals in each frame may be equal or less than a threshold Nmax. Nmax is referred to as an upper bound number. For example, the upper bound number Nmax may be 6 to 8. The upper bound number Nmax may be generated within each video frame. In one embodiment, the upper bound number Nmax is determined so as to ensure a real-time processing of image data using CNN. Applying the threshold to the number of the region proposals is optional. The region proposal module 402 may generate region proposals using no upper bound number Nmax.

The CNN observations module 406 includes a CNN object detector that has been pre-trained for object detection and object classification. The CNN object detector may include one or more CNNs, each being designed for a specific task. The CNN observations module 406 computes features for the region proposals and outputs computation results for all of the region proposals.

These computation results are referred to as CNN observations. In one embodiment, the CNN observations include bounding boxes for the objects (proposed locations of the objects) and classification (object type/class and classification score) of the objects. Each bounding box is defined by its location as well as vertical and horizontal dimensions (i.e., width and height). The classification score (also referred to as confidence) represents the likelihood of the object being categorized into a class, such as human, vehicle.

The tracker 408 tracks the detected objects across a series of video frames and generates tracking information. The tracker 408 associates each CNN observation with a target. By associating the CNN observation of the target with that of the previous frame, the track of the target is generated. The bounding box of the target may be used to identify to which region the target belongs or to determine that the target does not belong to any region. The tracking information generated by the tracker 408 includes the predicted targets' locations in the frame. The tracking information may be visualized and reviewed by the users.

The tracking information is provided to the region proposal module 402 as feedback (tracker feedback 410) to improve object detection and tracking performance. The tracker feedback 410 guides the region proposal module 402 to propose certain parts of the next frame to the CNN observations module 406. For example, the tracker feedback 410 is utilized to generate region proposals that likely contain most or all of the objects in the frame.

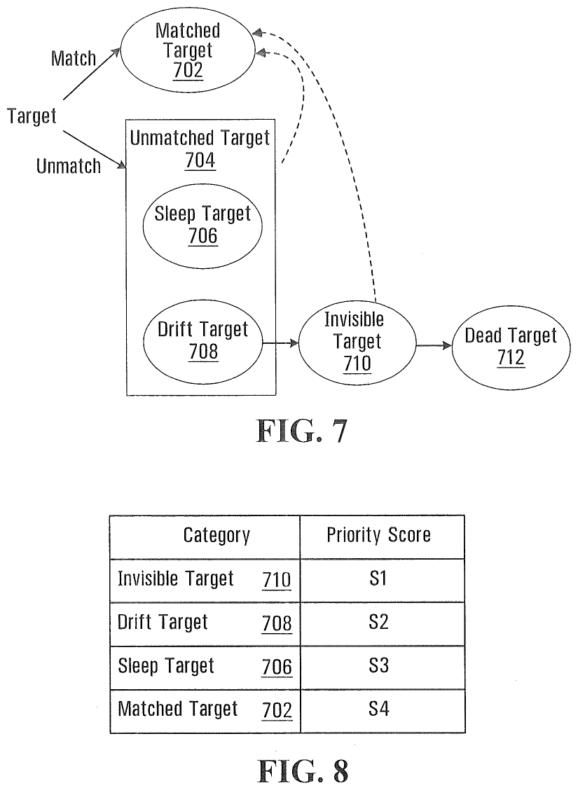

In one embodiment, the tracker feedback 410 is utilized to identify a high priority or urgent region in a video frame. The high priority or urgent region is, for example, a region where a “dying” target may be detectable. The dying target herein may include a target that has not had corresponding bounding boxes for a certain number of previous frames (for example, 704, 710 shown in FIG. 7). By proposing the high priority or urgent region to the CNN observations module 406, the CNN observations module 406 generates CNN observations for the high priority or urgent region, thereby potentially detecting (saving) the dying target. After the dying target is back to “live”, i.e. considered an active target (for example, 702 shown in FIG. 7), the tracker 408 or the object tracking module 306 may track that target without CNN observations, using other tracking algorithms. In the meantime, the region proposal module 402 can propose other regions to the CNN module observations 406 for other targets.

The region proposal module 402 receives various inputs including the tracker feedback 410 and inputs 420. The size and location of a region proposal is determined based on tracker feedback 410 and/or inputs 420. These inputs 420 and/or tracker feedback 410 provide information about the expected sizes and locations of the objects occurring in the scene. In one embodiment, the module 400 utilizes these inputs to propose regions with optimal size and locations to the CNN observations module 406 to improve object detection performance and reach higher detection accuracy. In one embodiment, these inputs may be utilized to maximize the probability that the region proposal has dimensions about 1.25-2.5 times larger than that of the object presented in a video frame.

The inputs 420 may include one or more motion vectors, Last Checking Time (LCT) map, and predefined regions. In one embodiment, the motion vector, the LCT map, and the predefined regions may be generated or updated in the video analytic module 224 or a server.

The predefined regions are a set of multiple overlapped regions that cover the entire frame (like a grid). Overlapping of the predefined regions is large enough to guarantee at least one of predefined regions completely covers an object. At the same time, the size of each of the predefined regions is comparable to the object size for a given location. For example, the size of each of the predefined regions may be close to twice the size of the objects for a given location. A subset of the predefined regions is utilized as initial candidates of region proposals. In one embodiment, the predefined regions are pre-generated from an object size map. The locations and sizes of the predefined regions are defined based on the object size map. The object size map may have the same dimensions as the frame. For a given location on the object size map, the map value represents an estimated object size in a pixel unit. The object size map may be calculated in self-learning manner by a self-calibration module based on the object detections. Using the object size map, the region proposals can cover the representation of all of the objects in a frame (i.e. not excluding any objects).

The motion vector is utilized to select regions and/or to merge the selected regions. The motion vector may be calculated from two consecutive frames in the video sequence. The motion vector may be calculated using various methods, such as a block matching method. In another embodiment, instead of using motion vectors, a pixel-value differencing method may be used to select regions and/or to merge the selected regions.

The LCT map describes how long since the region was input to the CNN observations module 406 for object detection. The LCT map may be updated every frame based on detection results of the last frame. The LCT map is utilized to prioritize which regions in a frame are to be chosen for object detection based on recent detection results. The LCT map and/or the predefined regions may be utilized to select regions with static objects.

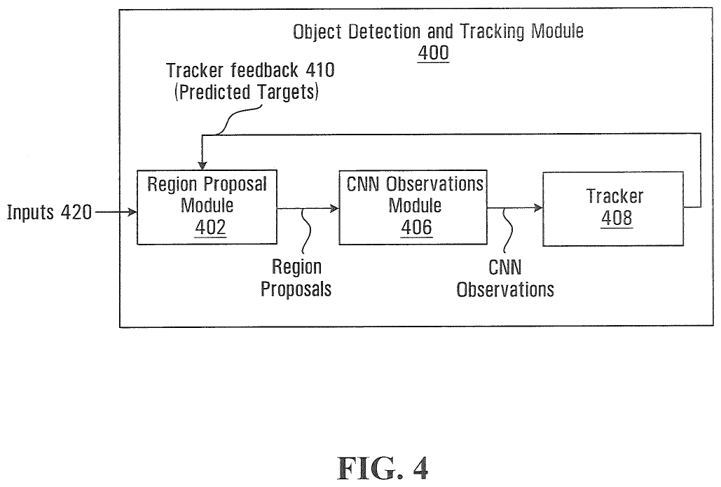

Referring now to FIG. 5, therein illustrated is a block diagram of a set of operational modules of the region proposal module 402 according to one embodiment. The region proposal module 402 includes a number of modules for generating region proposals. For example, the region proposal module 402 may include a region proposal generation module 502 for generating region proposals without the tracker feedback 410. The region proposals generated by the region proposal generation module 502 may be input to the CNN observations module 406 until the tracker feedback 410 is available.

The region proposal module 402 may further include a region proposal generation using tracker feedback module 504 for generating region proposals using the tracker feedback 410. The region proposals generated by the region proposal generation using tracker feedback module 504 are provided to the CNN observations module 406 when the tracker feedback 410 is available. In another embodiment, the modules 502 and 504 may be partially or entirely integrated. The modules 502 and 504 may share some algorithm.

The region proposal generation using tracker feedback module 504 may further include a detection statistics submodule 506 for creating and maintaining a statistical model based on the history of the inputs 420 and/or tracker feedback 410. Detection statistics submodule 506 may be utilized by tracker feedback module 504 to determine the probability of object detection in a region proposal. Tracker feedback module 504 and detection statistics submodule 506 may be partially or entirely integrated and may share one or more algorithms.

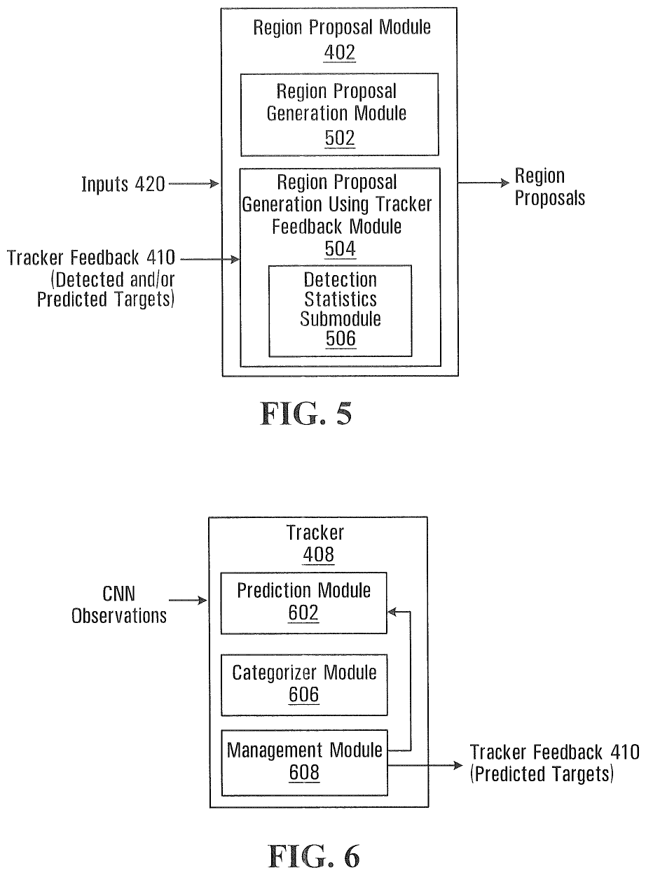

Referring now to FIG. 6, therein illustrated is a block diagram of a set of operational modules of the tracker 408 according to one embodiment. The tracker 408 comprises a number of modules for tracking targets and providing the feedback 410 to the region proposal module 402. For example, the tracker 408 includes a prediction module 602 for associating CNN observations with each target and predicting a location of each target. The prediction module 602 is also operable to estimate a velocity value for the target based on target locations on subsequent frames. The prediction module 602 may identify which target has no corresponding CNN observations for a series of video frames. The tracker 408 also includes a management module 608 for updating the targets and generating the tracker feedback 410 regarding predicted targets. The tracker 408 may communicate with other tracking modules and share the target locations of the predicted targets.

The tracker 408 also includes a categorizer module 606 for categorizing each predicted target based on the matching results. The categories assigned by the categorizer module 606 are referred to as status categories. These status categories form a part of the tracker feedback 410. In one embodiment, the status categories may indicate the priority of targets based on the target's need to be detected. In one embodiment, the status category assigned to a target may indicate how long since the target has been matched or detected.

In a further embodiment, the categorizer module 606 may use tracking information received from various modules employing different tracking algorithms to assign a status category to each predicted target. In a further embodiment, the prediction module 602, categorizer module 606 and management module 608 may be partially or entirely integrated and/or share some algorithm. An example of the status categories is schematically illustrated in FIG. 7.

Referring now to FIG. 7, therein illustrated is a state transition diagram of status categories assigned to a target by the tracker 408 according to one example embodiment. The status categories assigned by the tracker 408 include a matched target 702, an unmatched target 704, an invisible target 710, and a dead target 712. The unmatched target 704 category is further divided into a sleep target category 706 and a drift target category 708. These categories are used as a part of the tracker feedback 410 to improve the region proposals.

At the first frame, the region proposal module 402 generates region proposals without the tracker feedback 410. These region proposals are directly used by the CNN observations module 406. With the region proposals, the CNN observations module 406 generates CNN observations for all of the region proposals. At this point, there is still no output from the tracker 408.

In the following frames, the CNN observations module 406 keeps generating CNN observations for the region proposals in the corresponding frames. The tracker 408 then matches the CNN observation with each target to determine whether the particular target is still visible. A target matched to any CNN observation is categorized as a matched target 702. Since the region proposals may not cover the entire frame, there may be a target that is not included in any of the region proposals. A target not matching to a CNN observation is categorized as an unmatched target 704.

The tracker 408 (such as categorizer module 606 within tracker 408) compares a velocity value estimated for an unmatched target 704 with a threshold value to determine whether the unmatched target 704 is moving or not. For example, if the unmatched target 704 has a velocity value equal or close to zero, the tracker 408 recognizes that the unmatched target 704 is not moving, and the tracker 408 categorizes that unmatched target 704 as a sleep target 706. Otherwise the tracker 408 recognizes that the unmatched target 704 is moving, and the tracker 408 categorizes that unmatched target 704 as a drift target 708.

If the drift target 708 has not been matched to any CNN observations for more than a certain number of frames, the tracker 408 categorizes that drift target 708 as an invisible target 710.

If the invisible target 710 has not been matched with any CNN observations for more than a certain number of frames, the tracker 408 categorizes that invisible target 710 as a dead target 712. A target with the dead target 712 category is removed from tracking results.

The sleep target 706, the drift target 708 and the invisible target 710 may become matched targets 702 if they are matched with a CNN observation in the following frames. Once these targets become matched targets 702, the system may track them without CNN observations by using different tracking algorithms.

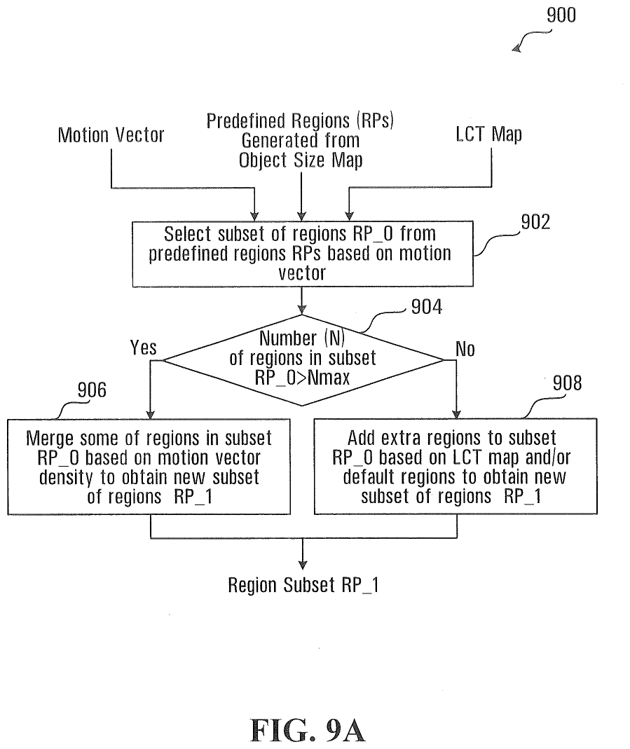

Referring now to FIG. 8, therein illustrated is an example of priority scores for the status categories assigned by the tracker 408 according to one example embodiment. The object detection and tracking module 400 sets a priority score to each status category. For example, a priority score S1 is assigned to an invisible target 710, a priority score S2 is assigned to a drift target 708, a priority score S3 is assigned to a sleep target 706, a priority score S4 is assigned to a matched target 702, where S1>S2>S3>S4. These priority scores indicate the priority with which a target will be detected. In one embodiment, the priority scores may be assigned to the predicted targets by the tracker 408 or the region proposal module 402. In another embodiment, the priority scores may be assigned or updated in the video analytic module 224 or a server.

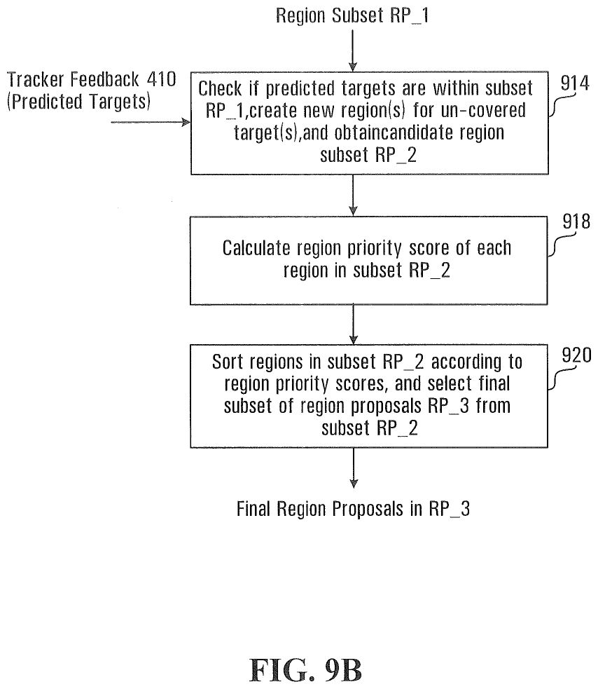

Referring now to FIGS. 9A and 9B, therein illustrated is flow diagrams of a process 900 for generating region proposals according to one example embodiment. The process 900 is implemented in the region proposal module 402. The region proposal module 402 has the inputs 420. In this embodiment, the inputs 420 include the motion vectors, the predefined regions (“RPs”) generated from the object size map, and the LCT map.

At 902, a subset of candidate regions (denoted as “RP_0”) is selected from the predefined regions RPs based on the motion vectors, i.e., the regions in subset RP_0 include motion. This eliminates regions that are not likely to contain any moving objects.

At 904, a number threshold criterion is applied to the region subset RP_0. It is determined if the number N of the regions in subset RP_0 is larger than the upper bound number Nmax. If the number N of the regions in subset RP_0 is larger than Nmax, the process proceeds to 906, otherwise the process proceeds to 908.

At 906, the number of regions in subset RP_0 is reduced. In this embodiment, some of the regions in subset RP_0 are merged, for example, based on motion vector density. The motion vector density is a percentage of pixels inside of a region proposal that have non-zero motion vectors. In one embodiment, overlapped regions with non-zero motion vector density may be merged. This forms a new subset of regions (denoted as “RP_1”). In a further embodiment, some criteria may be applied in merging the regions in subset RP_0, for example, the overlapped regions with non-zero motion vector density are merged only once. Merging regions in subset RP_0 creates one or more new larger regions. For example, the size of the merged region may be about twice as that of a predefined region PR. In a further embodiment, the number of regions in subset RP_0 may be reduced by selecting (or deleting) some of regions in subset RP_0, rather than merging the regions in subset RP 0.

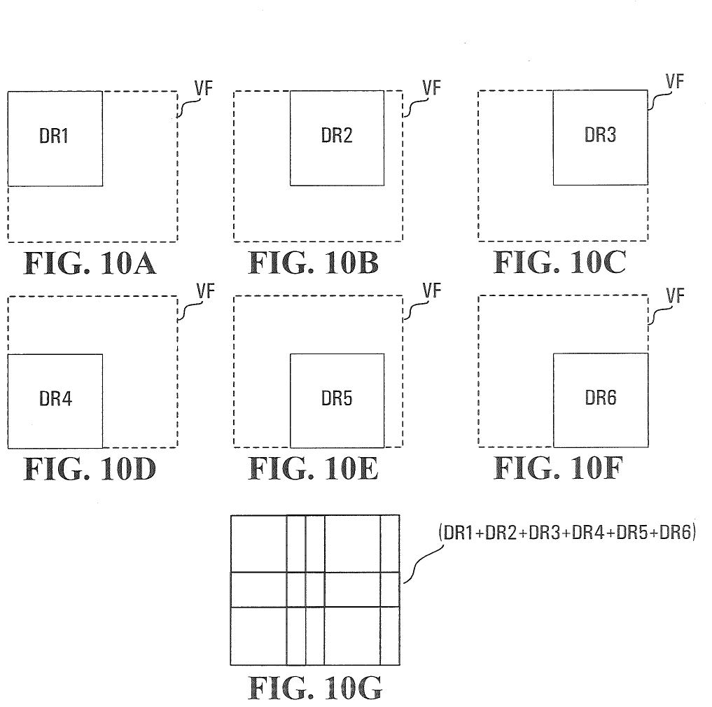

At 908, one or more extra regions are added to the regions in subset RP_0 using the LCT map and/or default regions if the number of regions is less than Nmax, to form a new subset of regions (denoted as “RP_1”) wherein the number of the regions in subset RP_1 is equal to the upper bound number Nmax. In one embodiment, a region that has not been input to the CNN observations module 406 for one or more frames may be selected as an extra region to be added. In one embodiment, the extra region may be selected from the default regions (the default regions collectively cover the entire frame). One example of the default regions and the associated frame is illustrated in FIG. 10A to 10G. If the number of regions in subset RP_0 is equal to Nmax, then RP_0=RP_1, i.e. no regions are added or removed.

In FIG. 10A to 10G, the boundary of the default region is illustrated in solid lines, and the boundary of the frame VF is illustrated in broken lines. In this example, there are 6 default regions DR1, DR2, DR3, DR4, DR5, and DR6. The default regions DR1-DR6 overlap each other within the frame VF as shown in FIG. 10G. In FIG. 10G, all of the boundaries of the default regions are shown for illustration purpose. These default regions are created in a sliding windows manner. For example, the default regions could be 2 by 3 partially overlapped bounding boxes windows over the whole frame as shown in FIGS. 10A to 100 and FIGS. 10D to 10F.

In one embodiment, until the tracker feedback 410 is available, the regions in subset RP_1 are input to the CNN observations module 406 as region proposals to be processed.

Turning back to FIG. 9B, the region proposal module 402 starts identifying a high priority or urgent region in a video frame. The region proposal module 402 has the tracker feedback 410 and the regions in subset RP_1 obtained at 906 or 908. In one embodiment, the tracker feedback 410 include a status category for each predicted target, such as “matched target”, “sleep target”, “drift target”, “invisible target”. In one embodiment, the tracker feedback 410 may include the priority score of each predicted target, such as S1, S2, S3, and S4.

At step 914, to prepare a subset of candidate regions (denoted as “RP_2”), it is determined whether each of the predicted targets are included in any region of the regions in subset RP_1. It is determined how much of the bounding box of the predicted target intersects with each of the regions in subset RP_1. For example, if the intersection area between the bounding box of a predicted target and a region is greater than a certain percentage K of a target area (i.e., the area of the bounding box) for a predicted target, the system determines that the predicted target is within the region, i.e. the target belongs to that region. In one embodiment, K may be 80%.

If a predicted target is considered as not within any of the regions in subset RP_1, that target is identified as an un-covered target. To detect the un-covered target, a new region is created based on the size of the un-covered target at the target location and the new region is added to the regions subset RP_1.

By the process at step 914, every predicated target is considered to be within one of the regions in subset RP_1 and/or any added new regions. At this point, the regions in subset RP_1 and any added new regions form the subset of candidate regions RP_2.

At step 918, a region priority score of each region in the candidate regions subset RP_2 is calculated. In one embodiment, using the predicted target(s) inside the corresponding region, a region priority score of that region is generated using the priority score of each predicted target. For example, if a target with the invisible target 810 category is considered as to be inside Region R1, the priority score S1 is added to the region priority score of Region R1.

At 920, all the candidate regions in subset RP_2 are sorted by its region priority score, and if the total number of the candidate regions in subset RP_2 is larger than Nmax, the top Nmax regions are selected as final set of region proposals (denoted as “RP_3”); if the total number of the candidate regions in subset RP_2 is equal to or less than Nmax, all of the regions in subset RP_2 are selected as final region proposals subset RP_3. The final region proposals in subset RP_3 are sent to the CNN observations module 406.

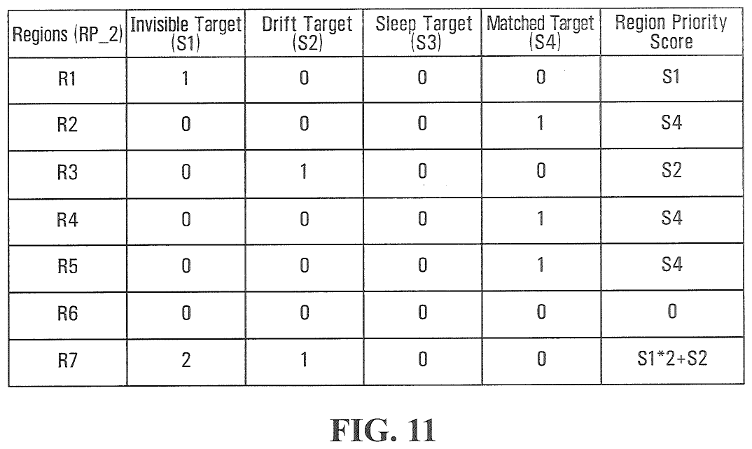

Referring now to FIG. 11, therein illustrated is an example of region priority scores utilized to select final region proposals according to one example embodiment. It is assumed that candidate regions subset RP_2 include regions R1, R2, R3, R4, R5, R6, and R7. For each region, the region priority score is calculated by summing up the priority scores of targets inside that region. In this example, region R7 has the highest region priority score (=2*S1+S2), and region R6 has the lowest region priority score (=0). In the case where Nmax=6, regions R1, R2, R3, R4, R5, and R7 form the final region proposals subset RP_3, and region R6 is excluded.

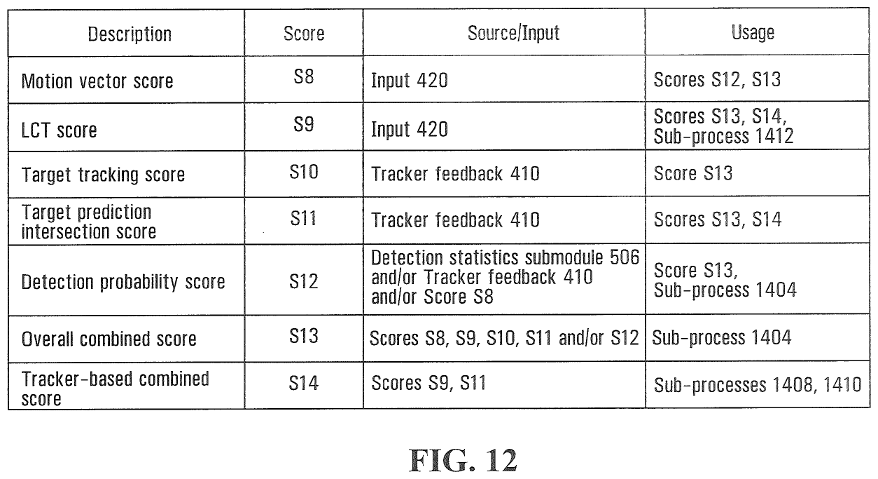

Referring now to FIG. 12, therein illustrated is an example of scores derived from the inputs 420, the tracker feedback 410, and the detection statistics submodule 506.

The motion vector score S8 represents the motion vector density in the region proposal. Score S8 may be computed from the motion vectors from Inputs 420. A higher motion vector density results in a larger score S8. In one embodiment, the motion vectors may undergo a nonlinear scaling to produce S8.

The LCT score S9 represents the time since the region was last input to the CNN observations module 406. A longer time results in a larger score S9. Score S9 may be computed from the LCT map from Inputs 420. In one embodiment, the LCT map may undergo a nonlinear scaling to produce score S9.

The target tracking score S10 represents the confidence in the tracking prediction for the targets inside the region proposal. Score S10 may be computed from the tracker feedback 410. A lower confidence in the tracking prediction results in a higher score S10. In one embodiment, the tracking confidence may undergo a nonlinear scaling to produce score S10. In another embodiment, the score S10 may also depend on the status category assigned by the tracker 408. For example, a moving target may have a higher score S10.

The target prediction intersection score S11 represents the degree of overlap of a region proposal with target prediction bounding boxes. Score S11 may be computed from the tracker feedback 410. A larger proportion of overlap area results in a higher score S11. In one embodiment, the overlap area may undergo a nonlinear scaling to produce S11. In one embodiment, the score S11 may depend on the motion status category from the tracker 408. The motion status categories include moving and stopped.

The detection probability score S12 represents the probability of finding a target detection in a region proposal. Score S12 may be computed by the detection statistics submodule 506. A higher probability results in a higher score S12. In one embodiment, the score S12 may depend on the tracker predictions and/or the motion vectors.

An overall combined score S13 is computed from motion vectors score S8, the LCT score S9, the target tracking score S10, the target prediction intersection score S11 and/or the detection probability score S12. In one embodiment, S13 is a weighted combination of scores S8, S9, S10, S11. In another embodiment, S13 comprises of only S12. In a further alternative embodiment, S13 may comprise of a combination of all five scores S8, S9, S10, S11, and S12.

A tracker-based combined score S14 uses the LCT score S9 and the target prediction intersection score S11 only.

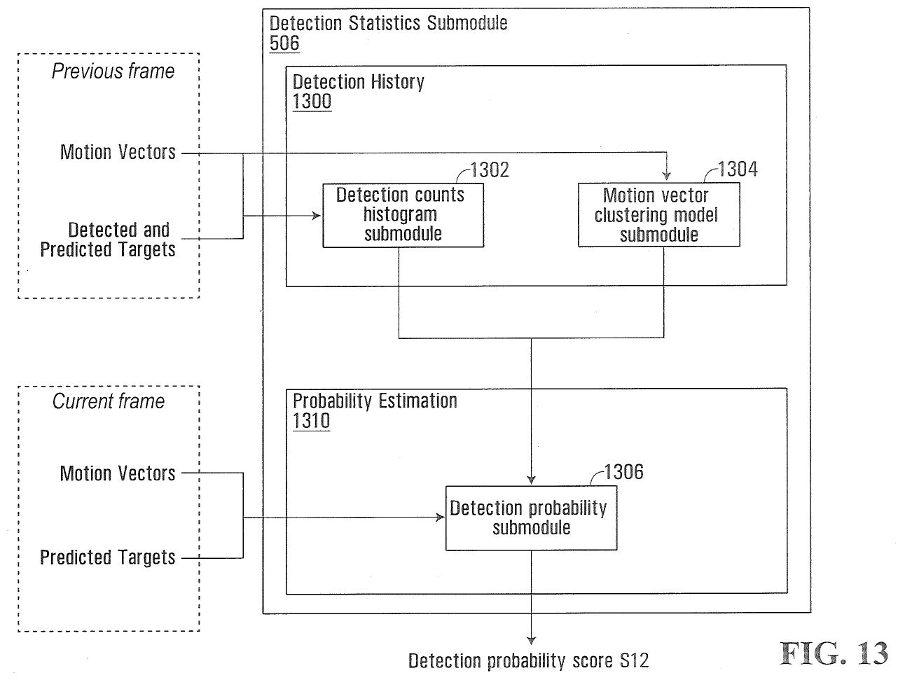

Referring now to FIG. 13, therein illustrated is a flow diagram of the region proposal detection statistics submodule 506 according to one embodiment. Detection statistics submodule 506 has two components: detection history 1300 and probability estimation 1310. The inputs of the detection history component 1300 are the tracker feedback 410 and the inputs 420 from the previous video frame. The inputs 420 are used to keep track of historical detection data and update detection statistics. The inputs of the probability estimation component 1310 are the tracker feedback 410 and inputs 420 for the current video frame, as well as the detection history component 1300. These inputs are used to compute the detection probability score S12.

At 1302, the tracker feedback 410 and inputs 420 from the previous video frame are utilized to update one or more histograms of detection counts. In one embodiment, the histogram is binned by motion vector score S8. The updating method of the histogram may be the usual average, moving average or exponential average of the detection counts. Different region proposals may use different histograms.

Still at 1302, different subcases for tracker feedback 410 and/or inputs 420 are distinguished. In one embodiment, there are two subcases of the predictions from tracker feedback 410. One subcase is when there are no predictions in the region proposal. The second subcase is when there are one or more predictions in the region proposal. These two subcases are disjoint; every tracker feedback falls into one of the two subcases.

Still at 1302, in one embodiment, two histograms of detection counts are utilized for each region proposal. The first histogram updates detection counts given the first subcase that there are no predictions in the region proposal. The second histogram updates detection counts given the second subcase that there are one or more predictions in the region proposal. Utilizing these two histograms recognizes the fact that the distribution of detection counts may be different when there are no predictions compared to when there are predictions. In further alternative embodiments, a different set of subcases and histograms may be utilized.

At 1304, the motion vectors from inputs 420 from the previous video frame are utilized to update a model of the motion vector score distribution of the region proposal. The model may be based on unsupervised learning methods such as sequential k-means clustering, for example.

Different region proposals may utilize different models.

Still at 1304, different subcases for inputs 420 are distinguished. In one embodiment, there are three subcases for motion vector score S8. One subcase is when score S8 lies in the interval from 0 to a small value m_1. A second subcase is when score S8 lies in the interval from m_1 to a medium value m_2. A third subcase is when score S8 lies in the interval from m_2 to the maximum value m_max. The value m_max is the maximum value of score S8. These three subcases are disjoint; every motion vector score S8 falls into one of the three subcases. The values m_1 and m_2 may be different for different region proposals.

Still at 1304, in one embodiment, the model of the motion vector score distribution clusters the motion vector score S8 into three clusters. The boundary of the cluster with the smallest motion vector scores defines the interval 0 to m_1. The boundary of the cluster with medium motion vector scores defines the interval m_1 to m_2. The boundary of the cluster with the largest motion vector scores defines the interval m_2 to m_max. Utilizing these subcases recognizes the fact that the different region proposals may have different motion vector score distributions.

At 1306, the tracker feedback 410 and inputs 420 from the current video frame are utilized to obtain the probability of detection from the detection statistics collected in 1300. The obtained probability of detection may depend on the subcases that are distinguished in 1302 and 1304. The detection probability score S12 is equal to the probability of detection, and it may also depend on the subcases that are distinguished in 1302 and 1304. The output of 1306 is the detection probability score S12.

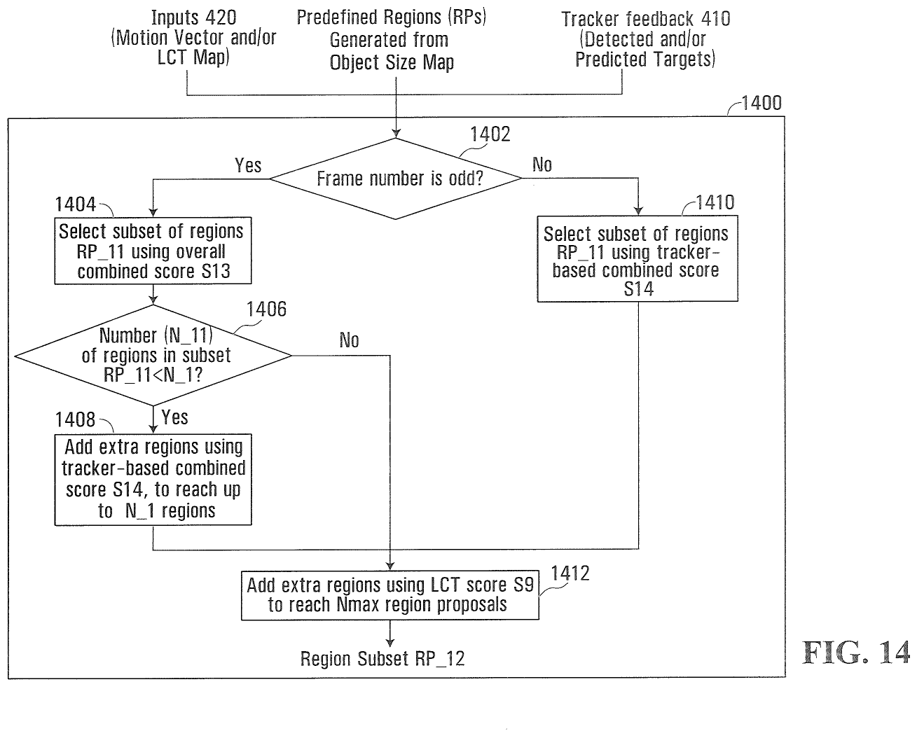

Referring now to FIG. 14, therein illustrated is a flow diagram of a process 1400 for generating region proposals according to another example embodiment, in which the submodule 504 is implemented in the region proposal module 402. In this embodiment, the inputs 420 include the motion vectors, the predefined regions generated from the object size map, and the LCT map.

The process 1400 begins at 1402. Step 1402 checks whether the frame number is even or odd, and alternates the next step between two sub-processes 1404 and 1410. Sub-process 1404 is executed if the frame number is odd. Sub-process 1410 is executed if the frame number is even. This method of alternating sub-processes allows for utilizing different scores throughout the duration of the video. In an alternative embodiment, the process 1402 may cycle through two or more sub-processes. Further in an alternative embodiment sub-process 1404 is executed if the frame number is even and sub-process 1410 is executed if the frame number is odd.

At sub-processes 1404 and 1410, an N_1 number of region proposals are selected, where N_1 is less than or equal to Nmax. In one embodiment, N_1 is equal to Nmax−2. This ensures that at least two region proposals are added when the LCT score S9 is used at the final sub-process 1412.

At 1404, in one embodiment, the at most N_1 region proposals with the highest overall combined score S13, and that additionally satisfy having positive motion vectors score S8, are selected to form the region subset RP_11. The number of regions in RP_11, N_11, could be equal to or fewer than N_1.

Still at 1404, in another embodiment, the at most N_1 region proposals with the highest detection probability score S12, and that additionally satisfy having both positive detection probability score and positive motion vectors score, are selected to form the region subset RP_11. If the number N_12 of region proposals selected by detection probability score S12 is less than N_1, then the remaining N_1-N_12 region proposals are selected using the procedure for sub-process 1404 as described in the preceding paragraph.

Still at 1404, in a further alternative embodiment, the region subset selection may utilize a different combination of scores.

At 1406, a number threshold criterion is applied to the region subset RP_11. If the number of the regions in subset RP_11, N_11, is less than N_1, the process 1400 proceeds to sub-process 1408 before proceeding to sub-process 1412. If the number of the regions in subset RP_11 equals N_1, the process 1400 proceeds directly to sub-process 1412.

At 1408, currently unselected region proposals with the highest tracker-based combined score S14, and that additionally satisfy having positive target prediction intersection score S11, are selected and included into region subset RP_11. Following sub-process 1408, the number of regions in RP_11, N_11, could be equal to or fewer than N_1.

At 1410, the frame number is even. The at most N_1 region proposals with the highest tracker-based combined score S14, and that additionally satisfy having positive target prediction intersection score S11, are selected and included into region subset RP_11. The number of RP_11, N_11, could be equal to or fewer than N_1.

At 1412, currently unselected region proposals with the highest LCT score S9, and that additionally satisfy not having an amount of overlap with any currently selected region proposal RP_11 that is larger than a pre-defined threshold value, are selected. The number of selected region proposals using LCT score S9 is Nmax −N_11, where N_11 is the number of region proposals in RP_11. These selected region proposals at 1412 are combined with RP_11 to produce the final region subset RP_12. The final region proposals in subset RP_12 are sent to the CNN observations module 406.

CNNs described herein may include a plurality of layers, for example, convolutional layers, pooling layers, activation layers, or other types of suitable layers. CNN layers may also comprise any one or more of, for example, fully-connected layers used for image classification, and layers that apply functions such as the Softmax function and non-linearity operations (e.g., ReLU). Layers may be shared between any suitable types of CNN. For example, layers may be shared between CNNs trained as a CNN detector that finds the location of an object-of-interest in an image. Examples of CNN detectors include a “single-shot detector” and/or a “you only look once” detector, as described in Liu, Wei, Dragomir Anguelov, Dumitru Erhan, Christian Szegedy, Scott Reed, Cheng-Yang Fu, and Alexander C. Berg, “SSD: Single Shot MultiBox Detector” in European Conference on Computer Vision, pp. 21-37, and Springer, Cham, 2016 and Redmon, Joseph, Santosh Divvala, Ross Girshick, and Ali Farhadi, “You Only Look Once: Unified, Real-time Object Detection” in Proceedings of the IEEE Conference on Computer Vision and Pattern Recognition, pp. 779-788, 2016, respectively. LeNet5 CNN (see, e.g., “Gradient-Based Learning Applied to Document Recognition”, Yann LeCun, Leon Bottou, Yoshua Bengio, and Patrick Haffner, Proc. of the IEEE, November 1998) and GoogLeNet CNN (“Going Deeper with Convolutions”, Christian Szegedy, Wei Liu, Yangqing Jia, Pierre Sermanet, Scott Reed, Dragomir Anguelov, Dumitru Erhan, Vincent Vanhoucke, Andrew Rabinovich, Computer Vision and Pattern Recognition (CVPR), 2015) may be used in at least some example embodiments.

CNNs in at least some example embodiments may use CNN architectures disclosed in US Patent Application publication 2018/0157916 entitled “System and Method for CNN Layer Sharing”, the entire contents of which is incorporated herein by reference. CNNs may include Support Vector Machine (SVM) classifiers.

While the above description provides examples of the embodiments with human and vehicles as the primary objects of interest, it will be appreciated that the underlying methodology of generating region proposals, creating bounding boxes of objects, tracking objects, and reselecting region proposals, is agnostic of the class of the object under consideration. A specimen object could include a bag, a backpack or a suitcase, for example. An appearance search system to locate vehicles, animals, and inanimate objects may accordingly be implemented using the features and/or functions as described herein without departing from the principles of operation of the described embodiments.

It is contemplated that any part of any aspect or embodiment discussed in this specification can be implemented or combined with any part of any other aspect or embodiment discussed in this specification.

While the above description provides examples of the embodiments, it will be appreciated that some features and/or functions of the described embodiments are susceptible to modification without departing from the spirit and principles of operation of the described embodiments. Accordingly, what has been described above has been intended to be illustrated non-limiting and it will be understood by persons skilled in the art that other variants and modifications may be made without departing from the scope of the invention as defined in the claims appended hereto. Furthermore, any feature of any of the embodiments described herein may be suitably combined with any other feature of any of the other embodiments described herein.

What is claimed is:

1. A method comprising:
generating a plurality of region proposals, each region proposal comprising a part of a video frame, the plurality of region proposals being input to a convolutional neural network (CNN) pre-trained for object detection;
detecting, using the CNN, one or more objects in a series of video frames;
tracking one or more targets based on outputs from the CNN across the series of video frames and generating tracking information on the one or more targets; and
refining the plurality of region proposals to be input to the CNN, based on the tracking information.

2. The method of claim 1, wherein the outputs from the CNN comprise a bounding box and a classification score for each detected object, wherein each bounding box is defined by a location and vertical and horizontal dimensions.

3. The method of claim 1, further comprising:
categorizing each of the one or more targets into a status category, based on the outputs from the CNN, the status category of a target indicating the time since the target was likely detected by the CNN.

4. The method of claim 3, further comprising:
for each of the one or more targets, identifying a region of the region proposals likely containing the target or a new region likely containing the target.

5. The method of claim 4, further comprising:
calculating a region priority score for each of the plurality of region proposals based on a priority score of the target that is likely within the identified region proposal, the priority score of the target being determined based on the corresponding status category.

6. The method of claim 5, wherein refining the region proposals comprises:
sorting the plurality of region proposals in a descending order by the region priorities scores, and selecting Nmax regions as final region proposals to be input to the CNN, wherein Nmax represents an upper threshold number.

7. The method of claim 1, wherein the region proposals include a non-zero motion vector and are selected from a plurality of predefined regions covering the frame.

8. The method of claim 7, wherein the predefined regions are generated from an object size map, the object size map's value for a given location in the object size map representing an estimated object size in pixels.

9. The method of claim 7, wherein the total number of the region proposals satisfies an upper threshold number criterion.

10. The method of claim 7, wherein generating region proposals comprises:
adding an additional region to the region proposals until the number of the region proposals satisfies an upper threshold number criterion.

11. The method of claim 10, wherein the additional region is determined using a default region or a last checking time map, the last checking time map describing the time since the local region was provided to the CNN.

12. The method of claim 9, wherein generating region proposals comprises:
merging at least two of the selected region proposals based on a motion vector density, the motion vector density defined as a percentage of pixels inside of a region proposal that have non-zero motion vectors.

13. The method of claim 2, further comprising:
for each of the one or more targets, identifying a region of the region proposals in which the target is likely contained based on the corresponding bounding box.

14. The method of claim 13, further comprising:
creating a new region for a target that is not likely within any of the region proposals and is likely within the new region.

15. The method of claim 14, further comprising:
categorizing each of the one or more targets into a status category, based on the outputs from the CNN, the status category of a target indicating the time since the target was likely detected by the CNN; and
calculating a region priority score for each region that likely contains a target based on the priority score of the target, the priority score of the target based on the corresponding status category.

16. The method of claim 15, wherein refining the region proposals comprises:
sorting regions including any region that likely contains a target and the region proposals, in a descending order of the region priority scores, and selecting Nmax regions as final proposal regions, wherein Nmax represents an upper threshold number.

17. A computer readable medium storing instructions, which when executed by a computer cause the computer to perform a method comprising:
generating a plurality of region proposals, each region proposal comprising a part of a video frame, the plurality of region proposals being input to a CNN pre-trained for object detection;
detecting, using the CNN, one or more objects in a series of video frames;
tracking one or more targets based on outputs from the CNN across the series of video frames and generating tracking information on the one or more targets; and
refining the plurality of region proposals to be input to the CNN, based on the tracking information.

18. A system comprising:
a module for generating a plurality of region proposals, each region proposal comprising a part of a video frame;
a CNN pre-trained for object detection, the plurality of region proposals being input to the CNN;
a tracker for tracking one or more targets based on outputs from the CNN across the series of video frames and generating tracking information on the one or more targets; and
a module further configured to refine the plurality of region proposals to be input to the CNN, based on the tracking information.
